(19) United States
(12) Patent Application Publication
(10) Pub. No.: US 2008/0106906 A1
(43) Pub. Date: May 8, 2008

(54) Clamp with movable light filter/lens/prism/diffuser

(75) Inventors: Jeffrey A. Lewsadder, Rolling Hills Estates, CA (US); Chris F. Bragg, Rolling Hills Estates, CA (US)

Correspondence Address: KENNETH J. HOVET;NORDMAN CORMANY HAIR & COMPTON LLP, P.O. BOX 9100, 1000 TOWN CENTER DRIVE, OXNARD, CA, 93031-9100, US

(73) Assignee: SheerVision, Inc.

(21) Appl. No.: 11/594,369

(22) Filed: Nov. 7, 2006

(51) Int. Cl. F21V 17/02

(52) U.S. Cl. 362/322

(57) ABSTRACT

A movable optical element such as a filter for a lamp includes a clamp for attaching the optical element to the lamp, and a frame for the optical element attached to the clamp with a hinge that allows the optical element to be positioned in, or out of the path of light from the lamp.

### FIELD OF THE INVENTION

This invention relates generally to a clamp for affixing a movable filter, lens, or diffuser to a lamp, particularly to a high intensity lamp for use in medical or dental environments.

### BRIEF SUMMARY OF THE INVENTION

This invention is directed to a movable aperture (hereafter sometimes called a “frame”) supporting an optical element such as a light filter, lens, prism or diffuser. The invention includes a clamp for attaching the frame to existing light sources and optical assemblies such as lamps used in medical and dental environments. For lamps with a circular opening/aperture through which light emerges from the lamp, the clamp may be a ring-shaped member with a flat anterior surface, and a cylindrical skirt at the periphery of the flat anterior surface, together forming a round opening of size and shape to fit around the anterior area or surface of a lamp. The flat surface and skirt may have a different shape, e.g., rectangular or square, that complements the shape of the opening through which light emerges from the lamp. At the edge of the ring-shaped member may be a hinge connected to a movable frame or holder for a lens, filter, prism, diffuser or other light-altering element that comprises a generally circular member for such an element, and a handle for manually grasping and moving/swinging the holder from a position where the element is in the path of light from the lamp to a position where the element is outside that path.

The filter or other optical element may be replacable, and the frame or holder may include a slot at the side through which an element may be inserted or removed and replaced. Additionally, the frame may include a snap in or threaded ring to retain optical components in place. Where the element is a filter, the filter itself may be made of a colorized polymer that may change the color of light passing through the filter. The filter may also be dichroic, or light absorbing glass.

In some embodiments, the hinge may comprise a spring assembly, e.g., a spring clip, that cooperates with a cam at the end of an extension member located at the edge of the frame or holder. These embodiments snap into and out of position over the path of light from the lamp.

### BRIEF DESCRIPTION OF THE DRAWINGS

Some embodiments of the invention appear in the accompanying drawings, in which:

FIG. 1 is a perspective view of a lamp assembly with a movable optical element, here a filter removably clamped to the lamp, and the filter positioned in the path of light that emerges from the lamp.

FIG. 2 is a perspective view of the lamp assembly and the attached, movable optical element shown in FIG. 1, with the element moved out of the path of light that emerges from the lamp.

FIG. 3 and FIG. 4 show side elevation views of the clamp assembly with the movable optical element shown in FIG. 1 and FIG. 2.

### DETAILED DESCRIPTION OF THE DRAWINGS

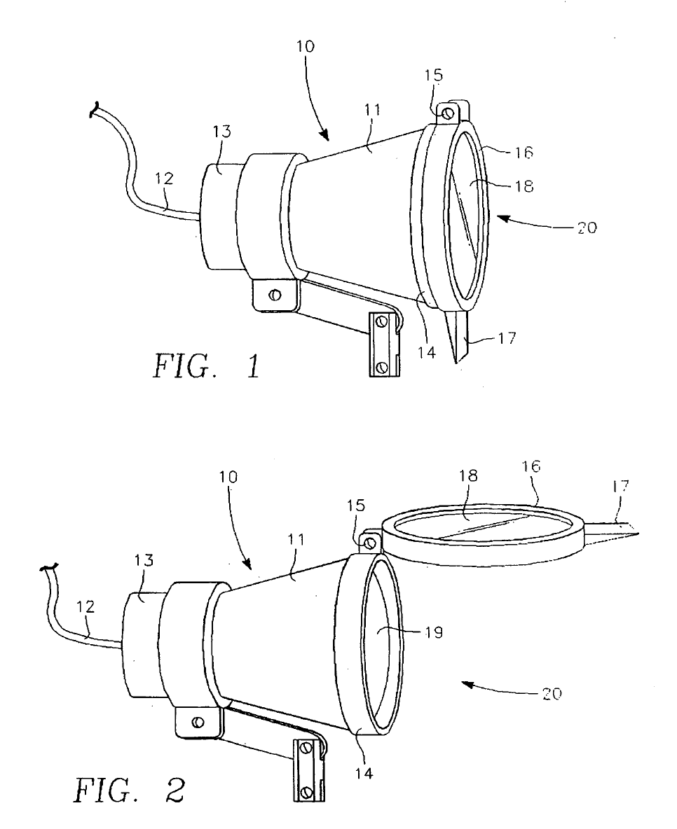

FIG. 1 shows lamp assembly 10 including lamp housing 11, power cord 12, adjustable lamp connector 13, and opening 19 through which light emerges from lamp 11. Movable light filter assembly 20 includes ring-shaped member 14, which clamps assembly 20 to lamp 11. Assembly 20 also includes hinge 15 at the edge of clamp 14, filter element 18 held in filter frame 16. Frame 16 includes handle 17 for grasping frame 16 to move filter element into the path 19 of light from lamp 11, as shown in FIG. 1, or out of the path of light, as shown in FIG. 2.

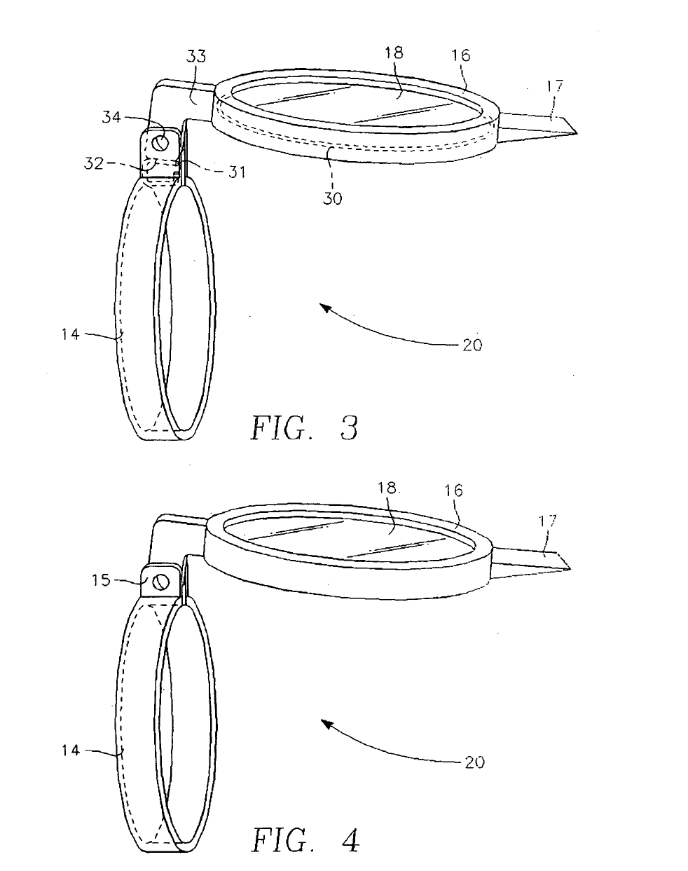

FIGS. 3 and 4 show side elevation views of the clamp and movable optical element assembly shown in FIGS. 1 and 2 without the lamp. In FIGS. 3 and 4, a filter or other optical element can be inserted or removed through slot 30 at the side of frame or holder 16. At the edge of frame 16 is extension member 33 which is connected to hinge 15 at pivot 34. Extension 33 includes, at one end, cam 32, which engages spring clip 32, and which permits frame 16 to snap into, and out of the path of light passing through ring-shaped member 14.

Throughout this disclosure, some structures are described as an “assembly.” As used herein, the term “assembly” identifies members which include multiple cooperating elements. The cooperation can refer to an aggregation of severable elements, or multiple elements integrally formed from single piece construction. No limitation is, therefore, intended, nor should any be inferred, by the use of the term “assembly.” Equivalent structures comprising fewer or more severable elements are within the scope of this invention.

Though the foregoing descriptions set forth illustrative embodiments in specific detail, variations, alterations and/or modifications may be made without departing from the spirit and scope of the invention. All such variations, alternatives and modifications come within the purview of the claims, and the claims should not be limited by the aforesaid specific embodiments.

We claim:

1. A movable filter element assembly comprising: a clamp of size and shape to be attached to a lamp at or near the opening from which light emerges from said lamp, and, attached to said clamp, a hinged, movable frame for a filter element and a replacable optical element in said frame.

2. The assembly of claim 1 wherein said clamp is a ring-shaped member, and said frame is ring-shaped, and of size and shape to cover the opening in the lamp through which light emerges.

3. The assembly of claim 1 wherein said frame includes an extension having a cam surface at one end, and said hinge includes a spring that engages said cam surface, and permits said frame to snap into and out of the path of light from said lamp.

4. The assembly of claim 1 wherein said frame includes an opening through which an optical element can be inserted into or removed from said frame.

5. The assembly of claim 1 wherein said optical element is selected from the group consisting of lenses, filters, prisms and diffusers.

6. The assembly of claim 5 wherein the optical element is a replacable light filter, and the filter is made of colorized polymer.
